(19) United States
(12) Patent Application Publication
(10) Pub. No.: US 2017/0363064 A1
(43) Pub. Date: Dec. 21, 2017

(54) BLADE FOR WIND POWER GENERATOR

(71) Applicant: INDUSTRY-UNIVERSITY COOPERATION FOUNDATION OF KOREA AEROSPACE UNIVERSITY, Goyang-si (KR)

(72) Inventors: Jae-Sung BAE, Seoul (KR); Soo-Yong LEE, Paju-si (KR)

(21) Appl. No.: 15/626,603

(22) Filed: Jun. 19, 2017

(30) Foreign Application Priority Data
Jun. 21, 2016 (KR) 10-2016-0077456

(51) Int. Cl. F03D 1/06

(52) U.S. Cl. CPC F03D 1/0675; F03D 1/0633; F05B 2240/221; F05B 2230/60; F05B 2230/50; F05B 2280/6003; F05B 2240/21

(57) ABSTRACT

Provided is a blade for a wind power generator including: a main spar; a front rib and a rear rib respectively located in the front side and the rear side of the main spar; and a skin, installed on the main spar, the front rib and the rear rib, constituting the outer skin of the blade. The skin is coupled by a zipper formed in the skin. The zipper includes an end portion zipper connecting the both end portions of the skin. The end portion zipper is covered by a cover portion provided in the skin. The cover portion covers the end portion zipper from the front side of the suction surface of the blade towards the rear side of the suction surface of the blade.

### CROSS-REFERENCE TO RELATED PATENT APPLICATION

This U.S. non-provisional patent application claims priority under 35 U.S.C. §119 of Korean Patent Application No. 10-2016-0077456 filed on Jun. 21, 2016 in the Korean Patent Office, the entire contents of which are hereby incorporated by reference.

### BACKGROUND

### 1. Technical Field

The present invention relates to a blade, more particularly, to a blade for a wind power generator.

### 2. Description of Related Art

Wind power generators that generate electric energy using wind power have been studied as an alternative energy source due to depletion of natural resources such as petroleum and coal natural gas due to industrial development and increase in population.

A wind power generator is provided with a nacelle at the top of a tower installed on the ground, and electrical energy is generated as a hub installed in the nacelle is rotated together with the blade by the wind blowing in from the front.

Conventional blades of wind power generator have been manufactured by mold-based method wherein synthetic resin and the like are poured into a mold. Therefore, in the case of a blade to be used in a large-sized wind power generator, there have been problems that the manufacturing cost of the mold is high and a new mold must be fabricated every time the shape of the blade is improved.

In addition, since the blades are fabricated by the mold-based method, there have been problems of limitations in the length of the blade for fabrication and its weight reduction.

In addition, since the blade is integrally formed using a mold, there has been problems of high transportation cost as well as frequent accidents occurring during transportation of the blade.

Accordingly, techniques for fabricating blades having a combined structure of ribs and spars have been researched, and such blade for wind power generators is disclosed in U.S. Pat. No. 9,188,102 (hereinafter, referred to as “Patent document 1”) and U.S. Patent Publication No. 2014-0119933 (hereinafter, referred to as “Patent document 2”).

In the blade for wind power generators of the Patent document 1, a fabric skin is coupled (bonded) to a span member and a rib of the blade to form an outer skin of the blade. In this case, rivet holes are respectively formed in a gasket, the span member and the rib which are provided in the fabric skin. Thus, the fabric skin is coupled (bonded) to the span member and the rib by inserting rivets into such rivet holes.

In the blade for wind power generators of the Patent document 2, a fabric strip is coupled to a rib of the blade to form an outer skin of the blade. In this case, an insertion slot is formed in the rib, and the fabric strip is inserted in the insertion slot. As described above, the fabric strip inserted into the insertion slot is fixed by an insertion member provided with a head to be inserted into the insertion slot, and due to this, the fabric strip is coupled to the rib.

For the case of the blade of the Patent document 1, a separate gasket formed with rivet holes must be provided in the fabric skin, and also separate rivet holes must be formed in the span member and the rib. Also, for the case of the blade of the Patent document 2, an insertion slot is formed in the rib, and an insertion member provided with a head must be provided separately. Thus, as described above, for the case of the blades of the Patent documents 1 and 2, there is a problem that a longer time is required for manufacturing the blade because the manufacturing process becomes complicated, and the manufacturing cost is increased as well.

For the case of the blades of the Patent documents 1 and 2, even when the fabric skin or the fabric strip is damaged due to the long time operation of the blade, the separation of the fabric skin or the fabric strip from the rib and the like is difficult, therefore, the replacement of the fabric skin or the fabric strip is not easy. Thus, there is a problem that the maintenance of the blade is difficult and the lifetime of the blade is reduced.

### PRIOR-ART DOCUMENTS

### Patent Documents

Patent document 1: US Pat. No. 9,188,102

Patent document 2: US patent Publication No. 2014-0119933

### SUMMARY

An objective of the present invention devised to solve above described problems is to provide a blade for a wind power generator capable of reducing the manufacturing time and the manufacturing cost, and at the same time, facilitating the maintenance of the blade.

A blade for a wind power generator according to a first feature of the present invention characterized in that and comprises: a main spar; a front rib and a rear rib respectively located in the front side and the rear side of the main spar; and a skin, installed on the main spar, the front rib and the rear rib, constituting the outer skin of the blade, wherein the skin is coupled by a zipper formed in the skin.

In addition, the zipper is characterized in that and comprises an end portion zipper connecting the both end portions of the skin, wherein the end portion zipper comprises: a first end portion zipper teeth and a second end portion zipper teeth respectively formed at the both end portions of the skin; and an end portion zipper slide, slidably installed at least in any one of the end portion zipper teeth among the first end portion zipper teeth and the second end portion zipper teeth, coupling the first end portion zipper teeth and the second end portion zipper teeth to each other, wherein the end portion zipper is located in the rear side of a suction surface of the blade.

In addition, it is characterized in that the end portion zipper is covered by the cover portion provided in the skin, wherein the cover portion covers the end portion zipper from the front side of the suction surface of the blade towards the rear side of the suction surface of the blade.

In addition, a plurality of the skins is installed on the main spar and the front rib and the rear rib, and forms the outer skin of the blade, wherein the zipper comprises a side portion zipper coupling the adjacent skins among the plurality of the skins, wherein the side portion zipper comprises: a first side portion zipper teeth and a second side portion zipper teeth respectively formed in the both side portions of the plurality of the skins; and a side portion zipper slide, slidably installed at least in any one of the side portion zipper teeth among the first side portion zipper teeth and the second side portion zipper teeth, coupling the first side portion zipper teeth and the second side portion zipper teeth of the adjacent skins among the plurality of the skins to each other, wherein the side portion zipper is located on the airfoil of the blade formed by the main spar, the first rib and the rear rib.

According to a blade for a wind power generator of the present invention, as previously described, there are advantageous effects as follows.

Since no separate rivets and rivet holes are required for the coupling of the skin to the components of the blade, reduction of the manufacturing time and the manufacturing cost of the blade for a wind power generator can be achieved.

Since the skin can be easily separated from the spar and the rib, the replacement of the skin becomes possible so that the maintenance is easy, and due to this, the lifetime of the blade for a wind power generator can be extended.

### BRIEF DESCRIPTION OF DRAWINGS

FIG. 1 is a side view of a wind power generator provided with a blade according to a preferred exemplary embodiment of the present invention.

FIG. 2 is a perspective view of a blade according to the preferred exemplary embodiment of the present invention.

FIG. 3 is a perspective view illustrating the main spar, the front rib and the rear rib in FIG. 2.

FIG. 4 is a plan view illustrating the skin of the blade in FIG. 2.

FIGS. 5 and 6 are the perspective views illustrating the installation of the skin on the main spar, the front rib and the rear rib in FIG. 3.

FIG. 7 is a perspective view illustrating the skin of the blade in FIG. 2 provided with a cover portion.

### DESCRIPTION OF SYMBOLS

| | |
|---|---|
| 10: wind power generator | 11: tower |
| 13: nacelle | 15: hub |
| 100: blade | 101: blade root |
| 102: blade tip | 103: leading edge |
| 104: trailing edge | 106: suction surface |
| 107: pressure surface | 110: main spar |
| 130: front rib | 131: front convex portion |
| 150: rear rib | 151: rear protrusion |
| 200: skin | 210: end portion zipper |

211: first end portion zipper teeth
212: second end portion zipper teeth
214: end portion zipper slide
216: first end portion zipper stopper
217: second end portion zipper stopper
230: side portion zipper
231: first side portion zipper teeth
232: second side portion zipper teeth
234: side portion zipper slide
236: first side portion zipper stopper
237: second side portion zipper stopper
250: cover portion

### DETAILED DESCRIPTION OF EMBODIMENTS

Hereinafter, the preferred exemplary embodiments of the present invention will be described with reference to the accompanying drawings as follows.

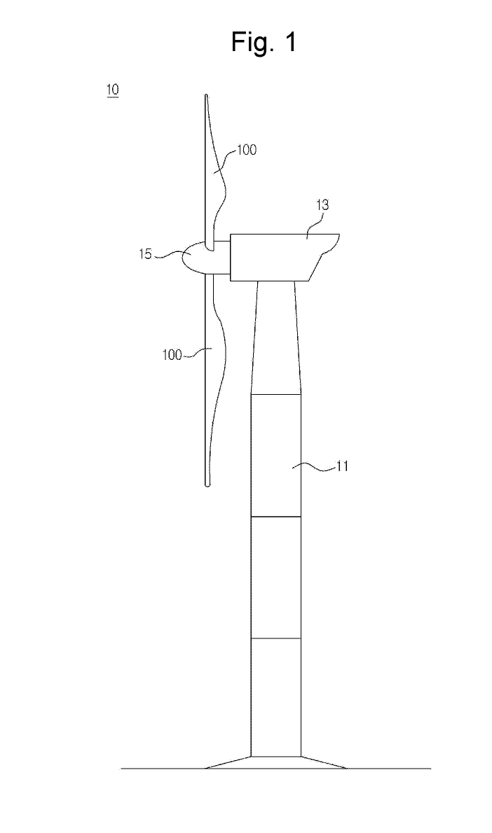

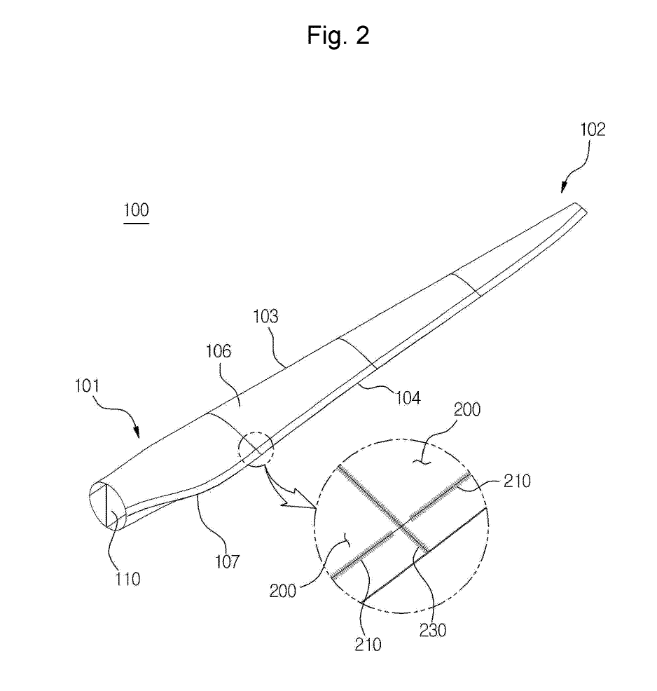

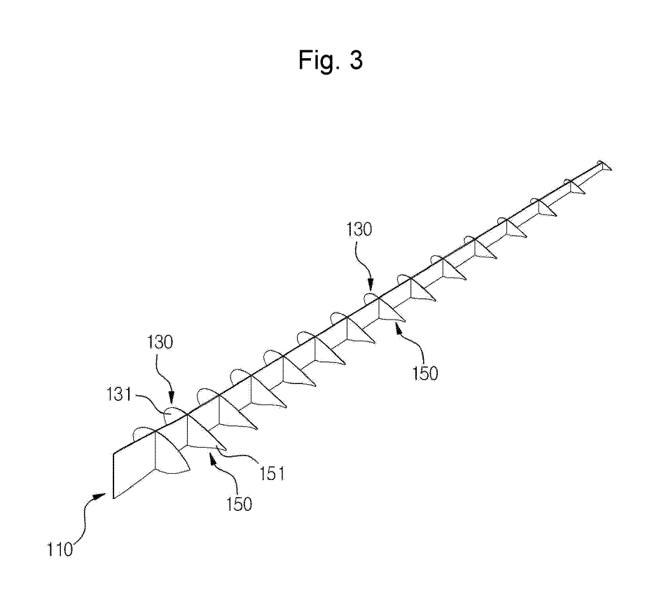

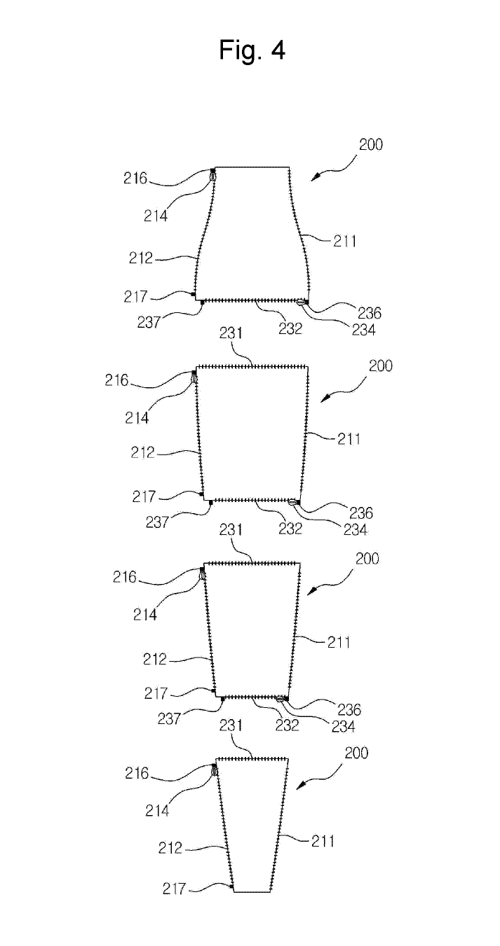

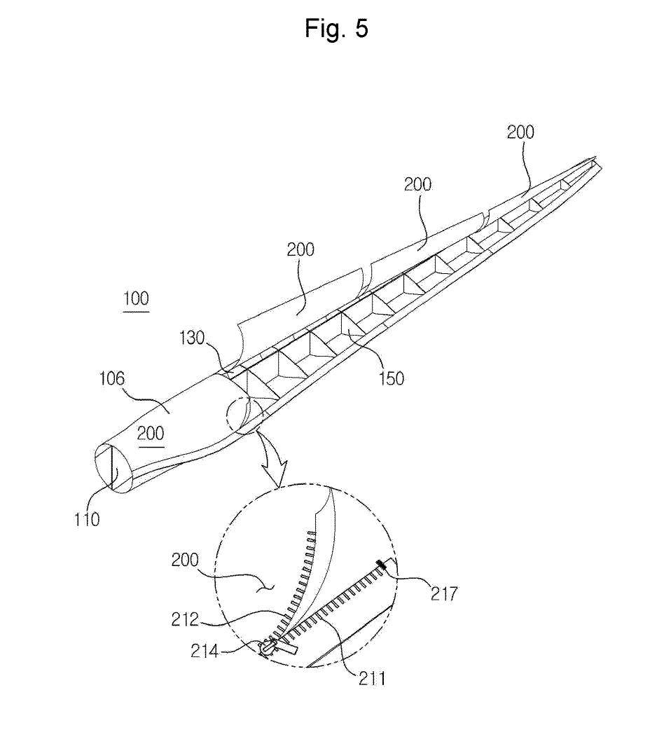

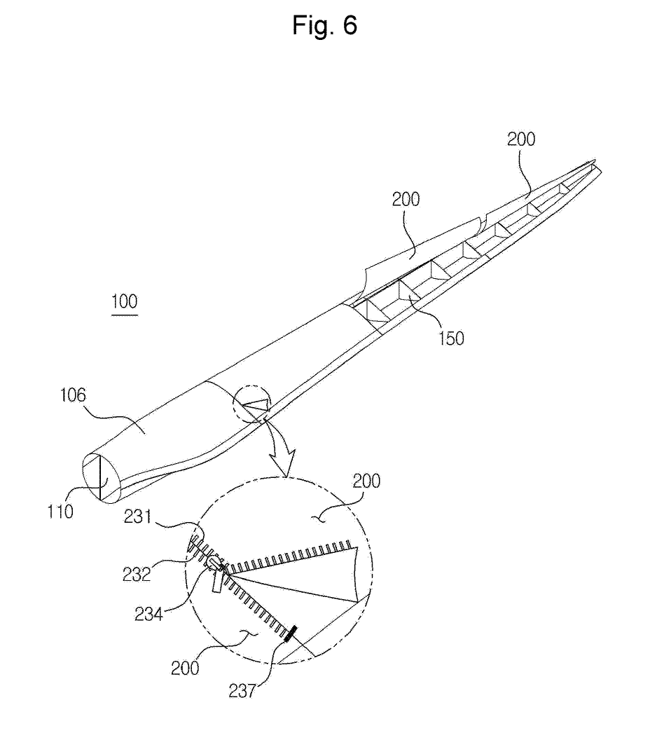

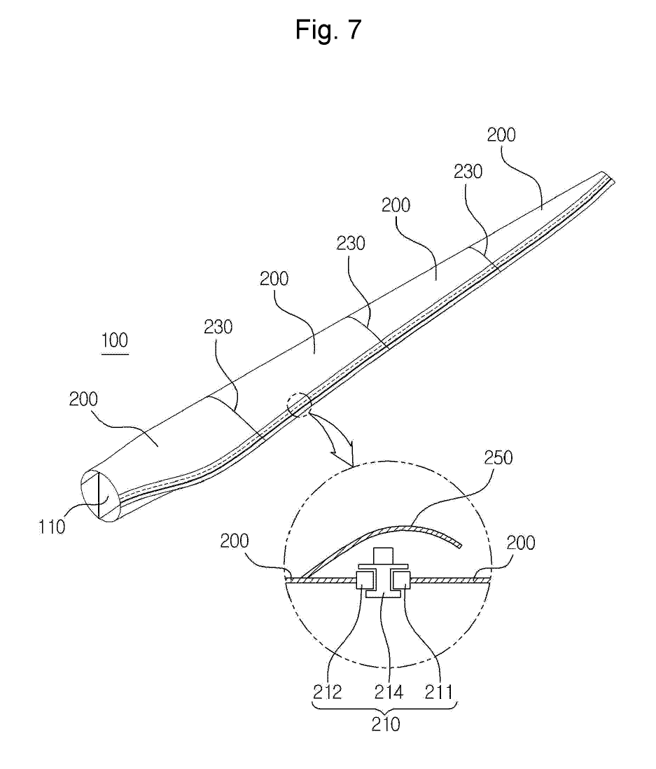

FIG. 1 is a side view of a wind power generator provided with a blade according to a preferred exemplary embodiment of the present invention; FIG. 2 is a perspective view of a blade according to the preferred exemplary embodiment of the present invention; FIG. 3 is a perspective view illustrating the main spar, the front rib and the rear rib in FIG. 2; FIG. 4 is a plan view illustrating the skin of the blade in FIG. 2; FIGS. 5 and 6 are the perspective views illustrating the installation of the skin on the main spar, the front rib and the rear rib in FIG. 3; and FIG. 7 is a perspective view illustrating the skin of the blade in FIG. 2 provided with a cover portion.

As illustrated in FIG. 1, a wind power generator 10 equipped with blades 100 according to the preferred exemplary embodiment of the present invention comprises: a tower 11, a nacelle 13, a hub 15 and a plurality of blades 100.

The tower 11 is fixedly installed in the ground surface, and performs supporting function for the nacelle 13, the hub 15 and the blades 100. In this case, it is preferred that the tower 11 is installed in a place where the atmospheric interference can be minimized such as a ridge of a mountain, above the sea, or a roof of a building.

The hub 15 is installed in the front end portion of the nacelle 13, and can be coupled to the nacelle 13 so that it can be rotated centered around the axis. Hereinafter, a blade 100 according to the preferred exemplary embodiment of the present invention will be described.

As illustrated in FIGS. 2 and 5, the blade 100 has an airfoil cross-section, and it may be installed in the hub 15 in multiple numbers in a way that they have a certain angle of attack with respect to the wind blowing from the front of the wind power generator 10.

A blade root 101 is provided at the one end of the blade 100, and a blade tip 102 is provided at the other end thereof. In this case, the direction from the blade root 101 towards the blade tip 102 is referred to as a spanwise direction.

The blade root 101 is the region wherein the blade 100 and the hub 15 are jointed, and the blade tip 102 is the region wherein the cross-sectional area of the blade 100 is getting smaller as it travels along the spanwise direction towards the other end of the blade 100.

In addition, a leading edge 103 is formed in the front side of the blade 100, and a trailing edge 104 is formed in the rear side of the blade 100. In this case, the direction from the leading edge 103 towards the flat back 104 is referred to as a chordwise direction.

The upper surface of the blade 100 is comprised of a suction surface 106, and the lower surface of the blade 100 is comprised of a pressure surface 107.

The suction surface 106 is an approximately convex surface, and it is a surface wherein the pressure is reduced because the wind blowing towards the leading edge 103 of the blade 100 is passing through this surface with a relatively higher speed.

The pressure surface 107 is an approximately concave surface, and it is a surface wherein the pressure is reduced because the wind blowing towards the leading edge 103 of the blade 100 is passing through this surface with a relatively slower speed.

The difference between the wind speeds in the suction surface 106 and the pressure surface 107, as described above, generates a lifting force directing from the pressure surface 107 towards the suction surface 106 in the blade 100, and the generated lifting force rotates the blade 100 thereby.

In other words, as the wind blowing from the front side of the wind power generator 10 passes through the surface of the blade 100, a lifting force is generated; the lifting force generated in this way rotates the blade 100 and the hub 15, and the rotational force of the blade 100 and the hub 15 is transferred to the nacelle 13 and converted into the electrical energy thereby.

The blade 100 according to the preferred exemplary embodiment of the present invention comprises: a main spar 110; a front rib 130 and a rear rib 150 respectively located in the front side and the rear side of the main spar 110; and a skin 200, installed on the main spar 110 and the front rib 130 and the rear rib 150, constituting the outer skin.

Hereinafter, the main spar 110, the front rib 130 and the rear rib 150 of the blade 100 according to the preferred exemplary embodiment of the present invention will be described.

As illustrated in FIGS. 3, 5 and 6, the main spar 110 has a length along the spanwise direction of the blade 100, and forms a frame along the spanwise direction of the blade 100.

In the front side surface of the main spar 110, a plurality of front ribs 130 is disposed along the spanwise direction of the blade 100; in the rear side surface of the main spar 110, a plurality of rear ribs 150 is disposed along the spanwise direction of the blade 100.

The front rib 130 has a cross-section similar to an ‘inverted D,’ and the rear side surface is connected to the front side surface of the main spar 110, and forms a frame along the spanwise direction of the blade 100 thereby.

A plurality of front ribs 130 may be connected and disposed in the front side surface of the main spar 110 along the spanwise direction of the blade 100.

In addition, the front surface of each of the plurality of front ribs 130 is formed with a front convex portion 131 forwardly convex, and due to such front convex portion 131, the shape of the leading edge 103 of the blade 100 is accomplished.

The front surface of the rear rib 150 is connected to the rear side surface of the main spar 110, and forms a frame along the chordwise direction of the blade 100 thereby.

A plurality of rear ribs 150 may be connected and disposed in the rear side surface of the main spar 110 along the spanwise direction of the blade 100.

In the rear side of the rear rib 150, a rear protruded portion 151 where the upper surface and the lower surface of the rear rib 150 are meet. Such rear protruded portion 151, together with the skin 200, forms the shape of the trailing edge 104 of the blade 100.

As described above, the plurality of front ribs 130 and the plurality of rear ribs 150 are disposed in multiple numbers respectively in the front side surface and the rear side surface of the main spar 110 along the spanwise direction of the blade 100. In this case, it is preferred that the plurality of front ribs 130 and the plurality of rear ribs 150 are disposed to have an equal separation distance. In other words, the plurality of front ribs 130 is disposed in the front side surface of the main spar 110 with an equal separation distance, and the plurality of rear ribs 150 is disposed in the front side surface of the main spar 110 with an equal separation distance, and it is preferred that the equal separation distances of the plurality of front ribs 130 and the plurality of rear ribs 150 are formed to be equal.

As described above, as the plurality of front ribs 130 and the plurality of rear ribs 150 have an equal separation distance in common, the weight of the blade 100 can be uniformly distributed thereby. In addition, by fabricating the width (length along the spanwise direction) of skin 300 for the blade to be the same as the equal separation distance of the plurality of front ribs 130 and the plurality of rear ribs 150, the skin 300 for the blade can be easily installed in the blade 100.

The above described main spar 110, front rib 130 and rear rib 150 form the cross-sectional shape of the blade 100, and such cross-section of the blade 100 is referred to as an airfoil.

The airfoil of the blade 100 has a forwardly convex shape due to the front convex portion 131 of the front rib 130, and this forms (forms) the leading edge 103 of the blade 100.

In addition, the rear side of the airfoil of the blade 100 has a protruded shape due to the rear protruded portion 151, and this forms (forms) the trailing edge 104 of the blade 100.

The airfoil of the blade 100 has approximately an upwardly convex shape due to the upper surface of the front rib 130 and the upper surface of the rear rib 150 of the main spar 110, and this forms the suction space 106 of the blade 100.

The airfoil of the blade 100 has approximately a concave shape due to the lower surface of the front rib 130 and the lower surface of the rear rib 150 of the main spar 110, and this forms the pressure space 107 of the blade 100.

The airfoil of the blade 100 may be formed in a way that the size thereof is getting smaller as it travels toward the blade tip 102.

In other words, in the spanwise direction of the blade 100, the size of airfoil of the blade (that is, cross-section of blade 100) may be formed in a way that it is getting smaller as it travels from the blade root 101 towards the blade tip 102, for this configuration, the sizes of the main spar 110, the front rib 130 and the rear rib 150 may be formed in a way that the sizes thereof are getting smaller as it travels along the direction towards the blade tip 102.

Hereinafter, the skin 200 of the blade 100 according to the preferred exemplary embodiment of the present invention will be described.

As illustrated in FIGS. 2 to 6, the skin 200 is installed on the main spar 110, the front rib 130 and the rear rib 150, and forms the outer skin of the blade 100 thereby.

The skin 200 may be comprised of many skins; in this case, a plurality of the skins 200 is installed on the main spar 110, and the front rib 130 and the rear rib 150, and may form the outer skin of the blade 100. In this way, when the plurality of the skins 200 forms the outer skin of the blade 100, there is an advantage that easiness in manufacturing can be achieved when the blade 100 is to be manufactured in a large size.

Each of the plurality of the skins 200 has a length and a width. The length of the skin 200 is corresponding to the length along the chordwise direction of the blade 100, and hereinafter, the both ends along the lengthwise direction of the skin 200 will be referred to as the both ends of the skin 200, that is, one end portion and other end portion of the skin. The width of the skin 200 is corresponding to the length along the spanwise direction of the blade 100, and hereinafter, the both ends along the widthwise direction of the skin 200 will be referred to as the both sides of the skin 200, that is, one side portion and other side portion of the skin 200.

It is preferred that the above described length of the skin, that is, the length between the both ends, is formed to be the size just enough to cover the main spar 110, and the front rib 130 and the rear rib 150, and due to this, the skin 200 can be easily installed on the main spar 110, and the front rib 130 and the rear rib 150.

In addition, when the skin 200 is comprised of many skins, although the width, that is the distance between the both side portions, of each of the plurality of the skins 200 may be formed in various sizes, it is preferred that the total width of the plurality of the skins 200, wherein all the multiple numbers of skins are combined, is corresponding to the length of the blade 100 along the spanwise direction, and due to this, the plurality of the skins 200 can be easily installed on the main spar 110, and the front rib 130 and the rear rib 150.

Each of the plurality of the skins 200 is composed of a composite material including a fabric (fiber) material, and a zipper is formed in each of the plurality of the skins 200.

The zipper formed in each of the plurality of the skins 200 comprises: an end portion zipper 210 coupling the both end portions of the plurality of the skins 200; and a side portion zipper 230 coupling the adjacent skins 200 among the plurality of the skins 200.

Hereinafter, the end portion zipper 210 will be described.

The end portion zipper 210 comprises: a first end portion zipper teeth 211; a second end portion zipper teeth 212; an end portion zipper slide 214 slidably installed in the second end portion zipper teeth 212; a first end portion zipper stopper 216; and a second end portion zipper stopper 217. The first end portion zipper teeth 211 is formed at the one end portion of the skin 200, and the second end portion zipper teeth 212 is formed at the other end portion of the skin 200. In this case, the first end portion zipper teeth 211 and the second end portion zipper teeth 212 are formed not in all but only in the region excluding a part of the region of the both end portions of the skin 200 to facilitate coupling of a first side portion zipper teeth 231 and a second side portion zipper teeth 232 of the side portion zipper 230, which will be described later. In other words, the first end portion zipper teeth 211 and the second end portion zipper teeth 212 are formed only in the region excluding the corner region where the both end portions and the both side portions meet, and the first end portion zipper teeth 211 and the second end portion zipper teeth 212 are not formed in the corner region. Thus, when teeth coupling between the first side portion zipper teeth 231 and the second side portion zipper teeth 232 are accomplished, the first end portion zipper teeth 211 and the second end portion zipper teeth 212 will not interfere the teeth coupling between the first side portion zipper teeth 231 and the second side portion zipper teeth 232, and due to this, the coupling of the end portion zipper 210 and the side portion zipper 230 can be accomplished easily.

The end portion zipper slide 214 is installed in the second end portion zipper teeth 212 and slidable within the range of the first end portion zipper stopper 216 and the second end portion zipper stopper 217 provided in the second end portion zipper teeth 212.

Thus, after the first end portion zipper teeth 211 is inserted into the first end portion zipper stopper 216, the end portion zipper slide 214 is slided from the first end portion zipper stopper 216 towards the second end portion zipper stopper 217 so that the first end portion zipper teeth 211 and the second end portion zipper teeth 212 can be coupled.

Unlike the above description, the end portion zipper slide 214 may be installed in the first end portion zipper teeth 211. In this case, the first end portion zipper stopper 216 towards the second end portion zipper stopper 217 is provided in the first end portion zipper teeth 211, and the end portion zipper slide 214 can be slided within the range of the first end portion zipper stopper 216 towards the second end portion zipper stopper 217 provided in the first end portion zipper teeth 211.

Hereinafter, the side portion zipper 230 will be described.

The side portion zipper 230 comprises: a first side portion zipper teeth 231 and a second side portion zipper teeth 232 respectively formed at the both side portions of the skin 200; a side portion zipper slide 234 slidably installed in the second side portion zipper teeth 232; and a first side portion zipper stopper 236 and a second side portion zipper stopper 237 provided in the second side portion zipper teeth 232.

The first side portion zipper teeth 231 is formed in the one side portion of the skin 200, and the second side portion zipper teeth 232 is formed in the other side portion of the skin 200. In this case, the first side portion zipper teeth 231 and the second side portion zipper teeth 232 is formed in the entire region of the both side portions of the skin 200.

The side portion zipper slide 234 is installed in the second side portion zipper teeth 232 and slidable within the range of the first side portion zipper stopper 236 and the second side portion zipper stopper 237 provided in the second side portion zipper teeth 232. Thus, after the first side portion zipper teeth 231 is inserted into the first side portion zipper stopper 236, the side portion zipper slide 234 is slided from the first side portion zipper stopper 236 towards the second side portion zipper stopper 237 so that the first side portion zipper teeth 231 and a second side portion zipper teeth 232 can be coupled through teeth.

Unlike the above description, the side portion zipper slide 234 may be installed in the first side portion zipper teeth 231. In this case, the first side portion zipper stopper 236 and the second side portion zipper stopper 237 are provided in the first side portion zipper teeth 231, and the side portion zipper slide 234 is slidable within the range of the first side portion zipper stopper 236 and the second side portion zipper stopper 237 provided in the first side portion zipper teeth 231.

The above described the first side portion zipper teeth 231 and the second side portion zipper teeth 232 may not be installed in all of the plurality of the skins 200.

To be explained more specifically, in the case of the skin 200 that forms the outer skin of the blade root 101 among the plurality of the skins 200, the first side portion zipper teeth 231 is not formed in the one side portion thereof since there is no other skin 200 to be coupled towards the one side portion of the skin 200. In this way, in the case of the skin 200 that forms the outer skin of the blade root 101 among the plurality of the skins 200, since there is no first side portion zipper teeth 231, the first end portion zipper teeth 211 and the second end portion zipper teeth 212 can be formed up to the corner along the direction of the one side portion of the skin 200.

In addition, in the case of the skin 200 that forms the outer skin of the blade tip 102 among the plurality of the skins 200, the second side portion zipper teeth 232 is not formed in the other side portion thereof since there is no other skin 200 to be coupled towards the other side portion of the skin 200. In this way, in the case of the skin 200 that forms the outer skin of the blade tip 102, since there is no second side portion zipper teeth 232, the first end portion zipper teeth 211 and the second end portion zipper teeth 212 can be formed up to the corner along the direction of the other side portion of the skin 200.

Hereinafter, a method wherein the above described plurality of the skins 200 is installed on the main spar 110, the front rib 130 and the rear rib 150 so as to manufacture the blade 100 according to an exemplary embodiment of the present invention will be described.

It is preferred that the plurality of the skins 200 is sequentially installed along the spanwise direction of the blade 100.

Thus, as illustrated in FIG. 5, first, a skin 200 (hereinafter, referred to as a first skin 200) to form the outer skin of the blade root 101 is wrapped around the main spar 110, the front rib 130 and the rear rib 150. In this case, the first skin 200 is positioned in a way that the end portion zipper 210 of the first skin 200, that is, the first end portion zipper teeth 211 and the second end portion zipper teeth 212, is located in the rear side of the suction surface 106 of the blade 100.

As described above, after the first skin 200 is positioned, as previously described, the first end portion zipper teeth 211 is inserted into the first end portion zipper stopper 216 provided in the second end portion zipper teeth 212, and then, the end portion zipper slide 214 is slided from the first end portion zipper stopper 216 up to the second end portion zipper stopper 217.

When the end portion zipper slide 214 is slided completely up to the second end portion zipper stopper 217, the first end portion zipper teeth 211 and the second end portion zipper teeth 212 are coupled each other through teeth, due to this, the both end portions of the first skin 200, that is, the one end portion and the other end portion are mutually coupled. Therefore, the first skin 200 is installed on the main spar 110, the front rib 130 and the rear rib 150 without using a separate adhesive and the like.

In this way, after the installation of the first skin 200 forming the outer skin of the blade root 101 completely, a second skin 200 adjacent to the first skin 200 is installed.

First, after the first side portion zipper teeth 231 of the second skin 200 is inserted into the first side portion zipper stopper 236 provided in the second side portion zipper teeth 232 of the first skin 200, the side portion zipper slide 234 is slided from the first side portion zipper stopper 236 up to the second side portion zipper stopper 237.

When the side portion zipper slide 234 is slided up to the second side portion zipper stopper 237 completely, the second side portion zipper teeth 232 of the first skin 200 and the first side portion zipper teeth 231 of the second skin 200 are mutually coupled through teeth, and due to this, the other side portion of the first skin 200 and the one side portion of the second skin 200 are mutually coupled. Therefore, the first skin 200 and the second skin 200 are mutually coupled without using a separate adhesive and the like.

In this way, after the first skin 200 and the second skin 200 are mutually coupled, the first end portion zipper teeth 211 and the second end portion zipper teeth 212 of the second skin 200 are mutually coupled using the same method as described in the first skin 200, and then the installation of the second skin 200 is completed.

The above described the installation methods for the first skin 200 and the second skin 200 are repeated up to the skin 200 that forms the outer skin of the blade tip 102 region, the installation of the plurality of the skins 200 is completed, and due to this, the plurality of the skins 200 is installed on the main spar 110, the front rib 130 and the rear rib 150, thereby forming the outer skin of the blade 100.

As described above, in the blade 100 according to the preferred exemplary embodiment of the present invention, a plurality of the skins 200 is installed on the main spar 110, the front rib 130 and the rear rib 150 through zipper-coupling so as to form the outer skin of the blade, therefore, unlike the blade of the prior art, since neither separate rivets nor rivet holes are required for the coupling of the skins, the reduction of the manufacturing time and cost of the blade 100 can be achieved.

In addition, the plurality of the skins 200 is coupled through zipper-coupling, that is, the coupling of the end portion zipper 210 and the side portion zipper 230, the skins 200 can be easily separated from the main spar 110, the front rib 130 and the rear rib 150 by releasing the teeth coupling of the end portion zipper 210 and/or the side portion zipper 230, and due to this, the skin 200 can be easily replaced. Thus, the maintenance of the blade 100 of the wind power generator 10 to be used long period of time or more can be facilitated, and due to this, the lifetime of the wind power generator 10 can be extended.

As described above, when the plurality of the skins 200 is installed on the main spar 110, the front rib 130 and the rear rib 150 and forms the outer skin of the blade 100, the side portion zipper 230 of each of the plurality of the skins 200 is located on the airfoil of the blade 100 formed by the main spar 110, the front rib 130 and the rear rib 150. In other words, the side portion zipper 230 is located on the airfoil of the blade 100 forming a kind of strip in the shape like the outer surface of the front rib 130 and the rear rib 150.

It is preferred that the side portion zipper slide 234 of the side portion zipper 230 is not to be exposed towards the outside, that is, the outer surface of the blade 100, to achieve this, the side portion zipper slide 234 may be installed towards the opposite location (the side portion zipper slide 234 is facing towards the inner surface of the blade 100) as illustrated in FIG. 6. Thus, the side portion zipper slide 234 is protected from being exposed to the outer surface of the blade 100; due to this, the outer surface of the blade 100 of the region, wherein the side portion zipper 230 is formed, can be maintained relatively smooth, so that the generation of the lifting force of the blade 100 can be facilitated.

As described above, when the plurality of the skins 200 is installed on the main spar 110, the front rib 130 and the rear rib 150 and forms the outer skin of the blade 100, every end portion zipper 210 of each of the plurality of the skins 200 is located in the rear side of the suction surface 106 of the blade 100. In this way, as the end portion zipper 210 is located in the rear side of the suction surface 106 of the blade 100, the lifting force of the blade 100 can be facilitated.

To be explained more specifically, as the wind is blowing towards the leading edge 103 of the blade 100 in order to rotate the blade 100, the wind is passing through the suction surface 106 of the blade 100 with a high speed. In this case, the front side of the suction surface 106, that is, the region, among the suction surface 106, located close to the leading edge 103, is the region to where the wind is directly blowing in, therefore, if the end portion zipper 210 is located in the front side of the suction surface 106, turbulence is formed so that the lifting force of the blade 100 cannot be generated effectively. However, as described above, when the end portion zipper 210 is located in the rear side of the suction surface 106, turbulence is not produced since the rear side of the suction surface 106 is not the region to where the wind is directly blowing in, and due to this, the generation of lifting force of the blade 100 is not affected, therefore the generation of lifting force of the blade 100 can be facilitated.

Furthermore, as described above, since the first end portion zipper teeth 211 and the second end portion zipper teeth 212 are not formed in all the region of the both end portions of the skin 200; it is possible that there may be a non-zipper-coupled region (as a corner portion where the both end portions of the skin 200 meet, and where the first end portion zipper teeth 211 and the second end portion zipper teeth 212 are not formed), however, since this is also located in the rear side of the suction surface 106, the generation of lifting force of the blade 100 is not affected significantly.

As illustrated in FIG. 7, in each of the plurality of the skins 200 of the blade 100 according to the preferred exemplary embodiment of the present invention may further comprise a cover portion 250.

In this case, the cover portion 250 is provided in the skin 200 in a way that the one end portion of the cover portion 250 and the both side portions of the cover 250 are connected to the skin 200. Thus, the cover portion 250 covers the end portion zipper 210 from the front side direction of the suction surface 106 of the blade 100 toward the rear side direction of the suction surface 106 of the blade 100. The cover portion 250 is provided in the way described above, so that the end portion zipper slide 214 of the end portion zipper 210 is not exposed to the outer surface of the blade 100, therefore the generation of the lifting force of the blade 100 can be facilitated. In addition, the region where the above described zipper-coupling is not accomplished is also covered by the cover portion 250, therefore, the seam portion of the region where the zipper-coupling is not accomplished is not exposed towards outside.

Furthermore, the cover portion 250 and the skin 200 can cover the end portion zipper 210 more certainly since the regions except the other end portion of the cover portion 250, in other words, the one end portion and the both side portions, are connected to one another.

To be explained more specifically, when the wind is blowing towards the leading edge 103 of the blade 100 and passing through the surface of the suction surface 106, the space formed between the cover portion 250 and the skin 200 is getting smaller due to the force of the wind so that the cover portion 250 and the skin 200 are more closely contacted, and due to this, the cover portion 250 can cover the end portion zipper 210 more certainly. Thus, the rear side of the suction surface 106 of the blade 100 can be maintained to be relatively smooth, and due to this, the generation of the lifting force of the blade 100 can be facilitated.

As described above, although the present invention has been described with reference to the preferred exemplary embodiments, various changes and alterations of the present invention can be made by those skilled in the art without departing from the spirit and the scope of the present invention written in the claims described herein below.

1. A blade for a wind power generator comprising:
a main spar;
a front rib and a rear rib respectively located in the front side and the rear side of the main spar; and
a skin, installed on the main spar, the front rib and the rear rib, constituting the outer skin of the blade, wherein
the skin is coupled by a zipper formed in the skin, wherein
the zipper comprises an end portion zipper connecting the both end portions of the skin, wherein
the end portion zipper is covered by a cover portion provided in the skin, and wherein
the cover portion covers the end portion zipper from the front side of the suction surface of the blade towards the rear side of the suction surface of the blade.

2. The blade for a wind power generator according to claim 1, wherein the end portion zipper comprises:
a first end portion zipper teeth and a second end portion zipper teeth respectively formed at the both end portions of the skin; and
an end portion zipper slide, slidably installed at least in any one of the end portion zipper teeth among the first end portion zipper teeth and the second end portion zipper teeth, coupling the first end portion zipper teeth and the second end portion zipper teeth to each other, wherein
the end portion zipper is located in the rear side of the suction surface of the blade.

3. The blade for a wind power generator according to claim 1, wherein
a plurality of the skins installed on the main spar and the front rib and the rear rib form the outer skin of the blade, wherein
the zipper comprises a side portion zipper coupling the adjacent skins among the plurality of the skins, wherein
the side portion zipper comprises:
a first side portion zipper teeth and a second side portion zipper teeth respectively formed in the both side portions of the plurality of the skins; and
a side portion zipper slide, slidably installed at least in any one of the side portion zipper teeth among the first side portion zipper teeth and the second side portion zipper teeth, coupling the first side portion zipper teeth and the second side portion zipper teeth of the adjacent skins among the plurality of the skins to each other, and wherein
the side portion zipper is located on the airfoil of the blade formed by the main spar, the first rib and the rear rib.
